(19) United States
(12) Patent Application Publication
(10) Pub. No.: US 2006/0205935 A1
(43) Pub. Date: Sep. 14, 2006

(54) Process for shaping cellulose ethers

(76) Inventors: Alexandra Hild, Soltau (DE); Marc Oliver Schmidt, Konigstein (DE); Axel Altmann, Walsrode (DE); Benedikt Langer, Syke (DE); Wilhelm Oppermann, Bomlitz (DE); Bernd Schriewer, Walsrode (DE); Heiko Thielking, Leverkusen (DE)

Correspondence Address: BAYER MATERIAL SCIENCE LLC, 100 BAYER ROAD, PITTSBURGH, PA, 15205, US

(21) Appl. No.: 11/342,992

(22) Filed: Jan. 30, 2006

(30) Foreign Application Priority Data
Feb. 3, 2005 (DE) 102005004893.5

(51) Int. Cl. C08B 11/20

(52) U.S. Cl. 536/86

(57) ABSTRACT

The present invention relates to a process for the manufacture of cellulose ethers. The process involves: (a) providing a perforated disk having a plurality of perforations; and (b) forcing feed cellulose ether through at least some of the perforations of the perforated disk, thereby forming compressed cellulose ether. The compressed cellulose ether formed in accordance with the method of the present invention has a higher bulk density and a more uniform particle size distribution than known cellulose ethers prepared by other processes.

### CROSS REFERENCE TO RELATED APPLICATION

The present patent application claims the right of priority under 35 U.S.C. § 119 (a)-(d) of German Patent Application No. 102005004893, filed Feb. 3, 2005.

### FIELD OF THE INVENTION

The present invention relates to a process for the manufacture of cellulose ethers which have a higher bulk density and a narrower particle size distribution than known cellulose ethers, by pushing them through a perforated disk.

### BACKGROUND OF THE INVENTION

In the manufacture of cellulose ethers, the shaping step represents an important process step for influencing the properties of the product. In particular, intensive properties such as grading curve and bulk density are influenced in this step.

The shaping process step is typically carried out after washing of the product and before drying and grinding thereof.

According to the state of the art, shaping is typically effected by cumulative agglomeration in horizontal shaking mixers, whereby the moist product is agglomerated, compacted and compressed (see for example, DE 20 28 310 and DE 33 08 420 A1).

Particular disadvantages of the cumulative agglomeration technology include the dependence of the cumulative agglomeration on the residence time in the mixer, which is necessarily related to the dimensions of the granulator, and the limited possibility of introducing energy. Dividing the residence time results in a non-uniform product. The agglomerates are only loosely stuck together, so disaggregation occurs rapidly. This gives rise to substantial proportions of very fine dust, which is undesirable for certain grades. The ability of the intensive properties of bulk density and grading curve to be influenced is therefore limited.

### SUMMARY OF THE INVENTION

The object is therefore to provide a process by which the fibrous product after washing is shaped into highly compressed, compact particles (pellets) so that the bulk density is increased and only a few granules, if any, with a grading curve below the desired particle size are formed in the subsequent grinding process. In addition, the granules formed should be as uniform as possible. Furthermore, other product properties should remain unaffected.

In accordance with the present invention, it has now been surprisingly found, that this object is achieved by a method of preparing cellulose ethers comprising:
(a) providing a perforated disk having a plurality of perforations; and
(b) forcing (also referred to herein as “pushing”) feed cellulose ether through at least some of the perforations of said perforated disk,
thereby forming compressed cellulose ether,
   wherein the feed celluloseether has a bulk density (e.g., from 200 g/l to 400 g/l) and the compressed cellulose ether has a bulk density (e.g., from 400 g/l to 800 g/l), the bulk density of the compressed cellulose ether being greater than the bulk density of the feed cellulose ether, and the compressed cellulose ether having a particle distribution of from 125 micrometers to 1000 micrometers and a mean particle size of 500 micrometers.

Other than in the examples, or where otherwise indicated, all numbers or expressions, such a those expressing structural dimensions, etc, used in the specification and claims are to be under stood as modified in all instances by the term “about.”

### DETAILED DESCRIPTION OF THE INVENTION

In one embodiment of the invention, the cellulose ether is fed into an apparatus that includes a vertical axle. Attached to the axle is a fixed disk which has perforations with a defined diameter-to-length ratio. Rotating on this disk are rollers (edge runners, wheels, rolls), which push the cellulose ether into the perforations and force it through. Underneath (or on the exit side of) the disk the compressed cellulose ether is separated by rotating strippers and divided into small pellets.

In another embodiment of the invention, the cellulose ether is pushed through the perforations in the die of a flat die press (also referred to as an edge runner mill), in which the rotating edge runners (wheels) run on a perforated die (disk). Underneath (or on the exit side of) the die a shearing device cuts the pellets to the desired length. At least one edge runner runs in the edge runner mill. It is conventional to have two edge runners, but there can also be more than two. This depends, for example, on the size of the unit and the diameter of the edge runners.

However, a further possibility is that, on a straight, perforated die, a wheel (roll, edge runner) pushes the cellulose ether through the die as it moves to and fro, thereby compressing it.

The cellulose ether is compressed as it passes through the perforations. The degree of compression can be adjusted via the geometry of the perforations. This regulates the energy necessary for the compression process. The cross-sectional shape of the shaped bodies is determined by the shape of the perforation cross-section.

In the case of circular perforations, the consistency of the compressed cellulose ether depends on the compression ratio P, P being defined as the ratio of the length of the perforation to the diameter of the perforation in the die. The compression ratio P should be between 0.5 and 5.0, preferably between 2 and 4.0.

The perforations can also have a square, rectangular, oval or irregularly shaped cross-section. The number of perforations per unit area of the disk depends on the stability of the disk.

Examples of cellulose ethers suitable for carrying out the process according to the invention include ionic and non-ionic cellulose ethers. Examples of ionic cellulose ethers which may be mentioned include at least one of carboxymethyl cellulose, hydroxyethyl carboxymethyl cellulose; carboxymethyl sulfoethyl cellulose and sulfoethyl cellulose, preferably carboxymethyl cellulose. Examples of non-ionic cellulose ethers which may be mentioned include at least one of hydroxyethyl methyl cellulose, hydroxypropyl methyl cellulose, hydroxyethyl cellulose, hydroxypropyl cellulose, ethyl hydroxyethyl cellulose and methyl cellulose, preferably hydroxyethyl methyl cellulose and hydroxypropyl methyl cellulose.

The cellulose ethers compressed by the process according to the invention have a higher bulk density and form more stable granules than cellulose ethers treated according to the state of the art, other properties being the same. Also, the particle size distribution is more uniform, as characterized by a correlation coefficient K between screen size [mm] and distribution function [%] of approximately 1.0 (i.e., a substantially linear relationship).

Typical bulk densities for commercially valuable cellulose ethers compressed by the process according to the invention are from 400 g/l to 800 g/l. Typical particle size distributions of these cellulose ethers are from 125 μm to 1000 μm with a mean particle size of 500 μm.

The uncompressed (or feed) material is typically introduced into the edge runner mill via a metering device (e.g., screw, belt). It is also possible to render the edge runner mill inert, e.g. with nitrogen or carbon dioxide. The Examples which follow will describe the process according to the invention, but without implying a limitation.

### EXAMPLES

### Comparative Example (Preparation According to the State of the Art)

The product CMC CRT 40000 (degree of substitution (DS) of 0.9, product moisture content 42%, viscosity of a 2% aqueous solution 40,000 mP·s) is introduced as the fibrous, alcohol-free raw material into a horizontal mixer and continuously granulated. The granules obtained are dried in a batch apparatus and then ground to the required fineness in an impact pulverizer with screening basket. The product is screened off above 1 mm.

Bulk density=621 g/l; proportion below 0.125 mm: 18 wt. %; K=0.979.

### Example 1 (According to the Invention)

Instead of using a horizontal mixer, the product CMC CRT 40000 (product moisture content 42%) is compression-granulated by the process according to the invention (6 mm perforation; P=4) and then dried and ground as described above.

Bulk density 711=g/l; proportion below 0.125 mm: 14 wt. %; K=0.995.

### Example 2 (According to the Invention)

Instead of using a horizontal mixer, the product CMC CRT 10000 (product moisture content 40%, viscosity of a 2% aqueous solution 10,000 mP·s) is compression-granulated by the process according to the invention (6 mm perforation; P=3) and then dried and ground as described above.

Bulk density=680 g/l; proportion below 0.125 mm: 12 wt. %; K=0.999

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method of preparing cellulose ethers comprising:
(a) providing a perforated disk having a plurality of perforations; and
(b) forcing feed cellulose ether through at least some of the perforations of said perforated disk,
thereby forming compressed cellulose ether.

2. The method of claim 1 wherein the feed cellulose ether is forced through said perforations at a compression ratio P of 0.5 to 5.0.

3. The method of claim 2 wherein said compression ratio P is 2.0 to 4.0.

4. The method of claim 1 wherein the feed cellulose ether is forced through said perforations by means of one or more rotating edge runners.

5. The method of claim 1 wherein the feed cellulose ether is forced through said perforations by means of one or more oscillating wheels.

6. The method of claim 1 wherein the feed cellulose ether is forced through said perforations by means of rolls.

7. The method of claim 1 further comprising separating the compressed cellulose ether, after passing through the perforations of the perforated disk, into pieces of desired length.

8. The method of claim 1 wherein the compressed cellulose ether is selected from the group consisting of carboxymethyl cellulose, hydroxyethyl carboxymethyl cellulose, carboxymethyl sulfoethyl cellulose, sulfoethyl cellulose, hydroxyethyl methyl cellulose, hydroxypropyl methyl cellulose, hydroxyethyl cellulose, hydroxypropyl cellulose, ethyl hydroxyethyl cellulose, methyl cellulose and combinations thereof.

9. The method of claim 1 wherein the compressed cellulose ether has a bulk density of from 400 g/l to 800 g/l.

10. The method of claim 9 wherein the compressed cellulose ether has a particle size distribution of from 125 μm to 1000 μm, and a mean particle size of 500 μm.

11. The compressed cellulose ether prepared by the method of claim 1.
